(19) United States
(12) Patent Application Publication
(10) Pub. No.: US 2017/0041504 A1
(43) Pub. Date: Feb. 9, 2017

(54) SERVICE PROVIDING SYSTEM, INFORMATION PROCESSING APPARATUS, PROGRAM, AND METHOD FOR GENERATING SERVICE USAGE INFORMATION

(71) Applicant: Yasuharu FUKUDA, Kanagawa (JP)

(72) Inventor: Yasuharu FUKUDA, Kanagawa (JP)

(73) Assignee: Ricoh Company, Ltd., Tokyo (JP)

(21) Appl. No.: 15/224,766

(22) Filed: Aug. 1, 2016

(30) Foreign Application Priority Data
Aug. 3, 2015 (JP) 2015-153406

(51) Int. Cl. H04N 1/44; H04N 1/00; H04L 29/06

(52) U.S. Cl. CPC H04N 1/4413; H04L 63/02; H04L 63/10; H04N 1/00344; H04N 2201/0094; H04N 2201/0039

(57) ABSTRACT

A service providing system of providing a first service to an image forming apparatus authenticated by a first authentication function authenticating using registered organization information and registered user information includes a use-request receiving unit receiving a use request to use the first service, a service-use information generating unit acquiring, when the received use request is from the image forming apparatus operated by the user, who is not authenticated by the first authentication function, information related to the user, who operates the image forming apparatus and is authenticated by a second authentication function from another service providing system providing a second service to the image forming apparatus authenticated by the second authentication function and generating service use information including the organization information and the user information, and a service providing unit providing the first service to the image forming apparatus operated by the user authenticated by the second authentication function.

### CROSS-REFERENCE TO RELATED APPLICATIONS

The present application claims priority under 35 U.S.C. §119 to Japanese Patent Application 2015-153406, filed Aug. 3, 2015. The contents of which are incorporated herein by reference in their entirety.

### BACKGROUND OF THE INVENTION

Field of the Invention

The present invention relates to a service providing system, information processing apparatus, program, and method for generating service usage information.

The present invention relates to a service providing system, an information processing apparatus, a program, and a method for generating service usage information.

Description of the Related Art

In recent years, companies introducing cloud services are increasing. The cloud service is a service provided by a cloud computing technology.

For example, Japanese Unexamined Patent Application Publication No. 2013-250894 discloses a structure of single sign-on (SSO) using security assertion markup language (SAML) as a technique of causing authentication between multiple servers existing in different domains to collaborate.

Further, “OpenID Connect” exists as a structure of ID collaboration enabling the authentication to be implemented using a single identification (ID) at a time of using wide variety of cloud services.

### SUMMARY OF THE INVENTION

According to a first aspect, there is provided a service providing system of providing a first service to an image forming apparatus authenticated by a first authentication function authenticating using registered organization information and registered user information including a hardware processor which executes an application program to implement a use-request receiving unit configured to receive a use request to use the first service from the image forming apparatus, which is operated by a user, a service-use information generating unit configured to, in a case where the received use request is from the image forming apparatus, which is operatad by the user, who is not authenticated by the first authentication function, acquire information related to the user, who operates the image forming apparatus and is authenticated by a second authentication function from another service providing system providing a second service to the image forming apparatus authenticated by the second authentication function and generate service use information that includes the organization information and the user information and is for using the first service using the information related to the user, and a service providing unit configured to provide the first service to the image forming apparatus, which is operated by the user authenticated by the second authentication function.

### BRIEF DESCRIPTION OF THE DRAWINGS

FIG. 1 is a structural diagram of an exemplary information processing system of a first embodiment of the present invention;

FIG. 2 is a structural diagram illustrating an exemplary hardware structure of a computer;

FIG. 3 is a processing block diagram of an exemplary service providing system of the first embodiment;

FIG. 4 is an explanatory diagram of a summary of a process of automatically generating information for using service providing system;

FIG. 5 is a sequence diagram of an exemplary process of automatically generating information for using the service providing system;

FIG. 6 is a sequence diagram of the exemplary process of automatically generating information for using the service providing system;

FIG. 7 is a sequence diagram of the exemplary process of automatically generating information for using the service providing system;

FIGS. 8A to 8G are views for explaining exemplary information made by the service providing system by the process up to step S40 illustrated n FIGS. 5 to 7;

FIG. 9 is a sequence diagram of an exemplary login process using the account of an external service;

FIGS. 10A to 10D are views for explaining exemplary processes of steps S61 to S63 illustrated in FIG. 9;

FIG. 11 is a sequence diagram of an exemplary process of associating with a tenant at a time of adding a new user;

FIGS. 12A to 12F are views for explaining exemplary processes of steps S84 to S86 illustrated in FIG. 11;

FIG. 13 is a sequence diagram of another exemplary process of associating with the tenant at the time of adding the new user;

FIGS. 14A to 14G are views for explaining exemplary processes of steps S103 to S105 illustrated in FIG. 13; and

FIG. 15 is a flowchart of an exemplary process of determining whether a new tenant is made.

### DESCRIPTION OF THE EMBODIMENTS

For example, there is an image forming apparatus using the cloud service. In a case where this image forming apparatus uses multiple cloud services, information for using each of the cloud services is registered so that the cloud services are ready for the use. Therefore, in a case where a use of a new cloud service is to be started, information for using the new cloud service is registered from a client terminal such as a personal computer (PC) so that the new cloud service is ready for the use.

The object of the embodiment of the present invention is to provide a service providing system, which enables a service to be easily used by an operation from an image forming apparatus, in consideration with the above points.

Hereinafter, an embodiment of the present invention is described with reference to figures.

### First Embodiment

### System Structure

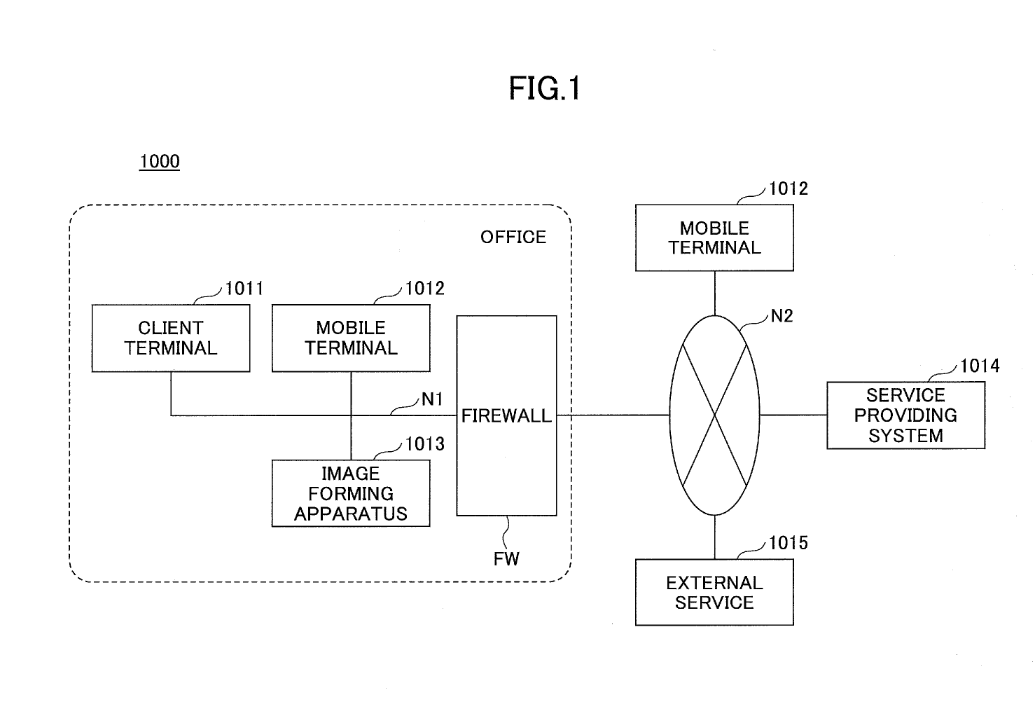

FIG. 1 is a structural diagram of an exemplary information processing system of the first embodiment of the present invention. The information processing system 1000 illustrated in FIG. 1 includes, for example, a network N1 such as an intra-office network and a network N2 such as the Internet.

The network N1 is a private network located on an inside of a firewall FW. The firewall FW is installed at a node between the network N1 and the network N2. The firewall FW detects and blocks an unauthorized access. A client terminal 1011, a mobile terminal 1012, and an image forming apparatus 1013 such as a multifunction peripheral are coupled to the network N1.

The client terminal 1011 is an example of a terminal apparatus. The client terminal 1011 can be substantialized by an information processing apparatus, in which an ordinary operating system (OS) or the like is installed. The client terminal 1011 includes a wired communication means or a wireless communication means. The client terminal 1011 is a terminal, which can be operated by a user, such as a desktop personal computer (PC) or a notebook PC.

The mobile terminal 1012 is an example of the terminal apparatus. The mobile terminal 1012 includes a wired communication means or a wireless communication means. The mobile terminal 1012 is a terminal which can be brought and operated by the user such as a smartphone, a mobile phone, and a tablet PC.

The image forming apparatus 1013 is an apparatus having an image forming function such as a multifunction peripheral. The image forming apparatus 1013 includes a wireless communication means or a wired communication means. The image forming apparatus 1013 is an apparatus of performing processes related to image formation such as a multifunction peripheral, a copier, a scanner, a printer, a laser printer, a projector, and an electronic blackboard. Referring to FIG. 1, the number of the client terminal 1011, the number of the mobile terminal 1012, and the number of the image forming apparatus 1013 are one, for example. However, the numbers of the client terminal 1011, the mobile terminal 1012, and the image forming apparatus 1013 may be multiple.

The mobile terminal 1012, a service providing system 1014, and an external service 1015 are coupled to the network N2.

The mobile terminal 1012 may exist in other than the network N1 such as the intra-office network. FIG. 1 illustrates an example that the mobile terminals 1012 are coupled to the network N1 and the network N1.

Each of the service providing system 1014 and the external service 1015 is substantialized by at least on information processing apparatus. Further, the service providing system 1014 and the external service 1015 are example of a system providing any service to the image forming apparatus 1013. The external service 1015 provides, for example, a package of web application service. Each one of a company, a department, and a group (hereinafter, referred to as a tenant) as a unit can subscribe for the external service 1015, and an account is issued for each one of the users.

The service providing system 1014 is an example of a service provider (SP) which provides a service to the image forming apparatus 1013 in response to information of authentication and permission issued by an identity provider (IdP). The external service 1051 is an example of the IdP.

The information processing system 1000 illustrated in FIG. 1 provides the image forming apparatus 1013 with the service providing system 1014 seamlessly coupled with the external service 1015 to substantialize a new value.

Therefore, the information processing system 1000 of the first embodiment uses the account of the external service 1015 as described below by an operation from the image forming apparatus 1013 to register the information for using the service providing system 1014. Therefore, the information processing system 1000 of the first embodiment generates the service providing system 1014 usable by the operation from the image forming apparatus 1013.

### <Hardware Structure>

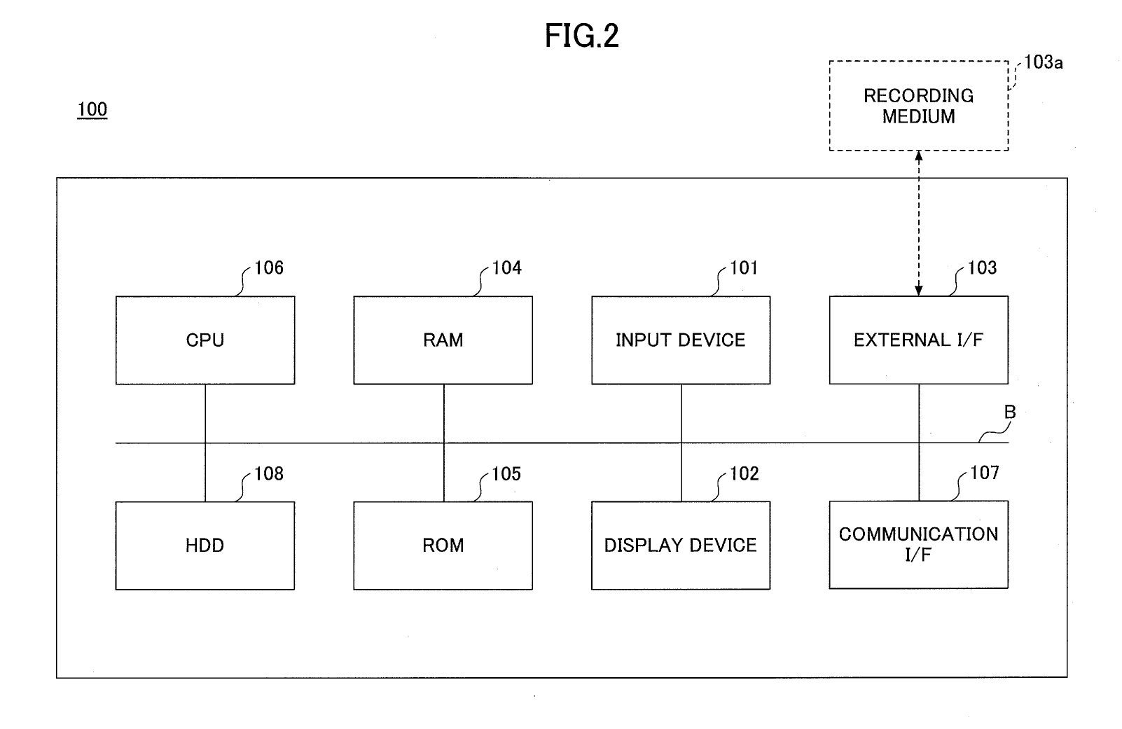

The client terminal 1011 and the mobile terminal 1012 are implemented by, for example, a computer having a hardware structure illustrated in FIG. 2. The at least one information processing apparatus implementing each of the service providing system 1014 and the external service 1015 are implemented by, for example, the computer having the hardware structure illustrated in FIG. 2.

FIG. 2 is a structural diagram illustrating an exemplary hardware structure of a computer. Referring to FIG. 2, the computer 100 includes an input device 101, a display device 102, an external interface (I/F) 103, a random access memory (RAM) 104, a read-only memory (ROM) 105, a central processing unit (CPU) 106, a communication interface (I/F) 107, a hard disk drive (HDD) 108, and so on, mutually connected by a bus B.

The input device 101 includes a keyboard, a mouse, a touch panel, or the like, by which a user can input various operation signals. The display device 102 includes a display or the like to display a processing result obtained by the computer 100. It is acceptable to use a mode where the input device 101 and the display device 102 are coupled when preferred so.

The communication I/F 107 is an interface provided to couple the computer 100 to the networks N1 and N2. Thus, the computer 100 can perform data communications through the communication I/F 107.

The HDD 108 is a non-volatile memory device storing a program and data. The program and the data, which are to be stored, are an operating system (OS) which is basic software to control the entire computer 100, application software providing various functions in the OS, and so on. The computer 100 may use a drive device using a flash memory (e.g., a solid state drive (SSD)) as a memory medium in place of the HDD 108.

The external I/F 103 is an interface with an external apparatus. The external apparatus is a recording medium 103a or the like. With this, the computer 100 can read information from the recording medium 103a and/or write information to the recording medium 103a through the external I/F 103. The recording medium 103a is a flexible disk, a compact disk (CD), a digital versatile disc (DVD), a secure digital (SD) memory card, a universal serial bus (USB) memory, or the like.

The ROM 105 is a non-volatile semiconductor memory (a memory device), which can hold a program and data even when a power source is powered off. The ROM 105 stores programs and data such as a basic input/output system (BIOS), an operating system (OS) setup, a network setup, or the like, which are executed at a time of starting up the computer 100. The RAM 104 is a volatile semiconductor memory (a memory device) temporarily storing at least one of a program and data.

The CPU 106 reads the program or the data from the memory device such as the ROM 105, the HDD 108, or the like. The read program or the read data undergo the process to substantialize controls or functions of the entire computer 100.

The hardware structure of the computer 100 of each of the client terminal 1011 and the mobile terminal 1012 can perform various processes described below. The at least one information processing apparatus substantializing each of the service providing system 1014 and the external service 1015 implements various processes described below by, for example, the hardware structure of the computer 100. A description of the hardware structures of the image forming apparatus 1013 and the firewall FW is omitted.

### <Software Structure>

### <<Service Providing System>>

The service providing system 1014 of the first embodiment is substantialized by, for example, a processing block illustrated in FIG. 3. FIG. 3 is a processing block diagram of an exemplary service providing system of the first embodiment. The service providing system 1014 substantializes the processing block diagram illustrated in FIG. 3 by executing the program.

The service providing system 1014 illustrated in FIG. 3 substantializes an application 1101, a common service 1102, a database (DB) 1103, an administration 1104, a business 1105, and a platform application programming interface (API) 1106.

For example, the application 1101 includes a portal service app 1111, an external service collaboration application (app) 112, a scan service app 1113, a print service app 1114, and an agent 1115.

The portal service app 1111 is an application providing a portal service. The portal service provides a service as an entrance for using the service providing system 1014. The external service collaboration app 1112 provides a service collaborating with the external service 1015. The scan service app 1113 is an application for providing a scan service. The print service app 1114 is an application providing a print service. The application 1101 may include another service app.

The agent 1115 protects the external service collaboration app 1112, the scan service app 1113, and the print service app 1114 from an unauthorized request 1114. The external service collaboration app 1112, the scan service app 1113, and the print service app 1114 are protected from the unauthorized request by the agent 1115, and receives a request from, for example, the image forming apparatus 1013 having an authorized authentication ticket.

For example, the platform API 1106 includes the portal service app 1111, the external service collaboration app 112, the scan service app 1113, a print service app 1114, and so on are interfaces for using the common service 1102. The platform API 1106 is an interface previously defined so that the common service 1101 receives a request from the application 1101. The platform API 1106 is structured by, for example, a function, a class, or the like.

The platform API 1106 can be substantialized by, for example, a Web API which can be used through the network when the service providing system 1014 is structured by multiple information processing apparatuses.

The common service 1102 includes an authentication and permission unit 1121, a tenant administering unit 1122, a user administering unit 1123, a license administering unit 1124, an apparatus administering unit 1125, a temporary image storing unit 1126, a log collecting unit 1127, an external service administering unit 1128, and an image-processing workflow-controlling unit 1130.

The image processing workflow-controlling unit 1130 includes a message queue 1131 and at least one worker (Worker) 1132. The worker 1132 substantializes a function such as an image conversion or an image transmission.

The authentication and permission unit 1121 performs authentication and permission based on a login request received from an office apparatus such as the client terminal 1011, the image forming apparatus 1013, or the like. The office apparatus is a general term of the client terminal 1011, the mobile terminal 1012, the image forming apparatus 1013, and so on.

The authentication and permission unit 1121 accesses, for example, a user information memory unit 1143, a license information memory unit 1144, or the like, which are described below, and authenticates and permits the user. Further, the authentication and permission unit 1121 accesses, for example, a tenant information memory unit 1142, the license information memory unit 1144, the apparatus information memory unit 1150, or the like described below to perform authentication of the image forming apparatus 1013 or the like.

The tenant administration unit 1122 administers tenant information stored in the tenant information memory unit 1142 described below. The user administration unit 1123 administers the user information stored in the user information memory unit 1143 to be described below.

The license administering unit 1124 administers the license information stored in the license information memory unit 1144 described below. The apparatus administering unit 1125 administers apparatus information stored in the apparatus information memory unit 1150 described below. The temporary image storing unit 1126 stores a temporary image in a temporary image memory unit 1148 described below and acquires the temporary image from the temporary image memory unit 1148.

The log collecting unit 1127 administers the log information stored in the log information memory unit 1141 described below. The external service administering unit 1128 administers external service tenant information and external service user information, which are related to the external service 1015 and described below.

The image processing workflow-controlling unit 1130 controls a workflow related to image processing based on a request from the application 1101. The message queue 1131 includes queues corresponding to types of the processes. The image processing workflow controlling unit 1130 inputs a message of a request related to a process (a job) into the queue corresponding to the type of the job.

The worker 1132 monitors the corresponding queue. When the message is input in the queue, the worker 1132 performs a process such as the image conversion and the image transmission corresponding to the type of the job. The message input to the queue may be mainly read out (Pull) by the worker 1132, or may be provided (Push) from the queue to the worker 1132.

The database 1103 illustrated in FIG. 3 includes the log information memory unit 1141, the tenant information memory unit 1142, the user information memory unit 1143, the license information memory unit 1144, the session information memory unit 1145, the external service tenant information memory unit 1146, the external service user information memory unit 1147, the temporary image memory unit 1148, the job information memory unit 1149, the apparatus information memory unit 1150, and the setup information memory unit 1151 inherent in the application.

The log information memory unit 1141 stores log information. The tenant information memory unit 1142 stores tenant information. The user information memory unit 1143 stores user information. The license information memory unit 1144 stores the license information. The session information memory unit 1144 stores the session information.

The external service tenant information memory unit 1146 stores external service tenant information described below. The external service user information memory unit 1147 stores external service user information described below.

The temporary image memory unit 1148 stores a temporary image. The temporary image is a file or data such as a scanned image processed by, for example, the worker 1132. The job information memory unit 1149 stores information (job information) of the request related to a process (a job). The apparatus information memory unit 1150 stores apparatus information. The setup information memory unit 1151 inherent in the application stores setup information inherent in the application 1101.

For example, the administration 1104 illustrated in FIG. 3 includes a monitoring unit, a deploying unit, a server account administering unit, and a server login administering unit. For example, the business 1105 illustrated in FIG. 3 includes a client information administering unit, a contract administering unit, a sales administering unit, a license administering unit, and a development environment unit. The license administering unit 1160 performs an issuance of a tenant license, an issuance of a service license, and so on described below.

The service providing system 1014 functions as an integrated platform for providing a common service such as the authentication and permission or a workflow related to image processing and a service group for providing an application service such as a scan service, external service collaboration, or the like.

The integrated platform is structured by, for example, the common service 1102, the database (DB) 1103, the administration, and the platform API 1106. The service group includes, for example, the application 1101 and the platform API 1106.

In the service providing system 1014 illustrated in FIG. 3, by adopting the structure where the service group and the integrated platform are separated, it is possible to easily develop the application 1101 using the platform API 1106.

A mode of classifying the processing blocks of the service providing system 1014 illustrated in FIG. 3 is an example. The application 1101, the common service 1102, the DB 1103, the administration 1104, and the business 1105 may not be classified in a hierarchy illustrated in FIG. 3. As long as the processes of the service providing system 1014 of the first embodiment can be performed, a relationship of the hierarchy illustrated in FIG. 3 is not specifically limited.

### <<Automatic Generation of Information for Using Service Providing System>>

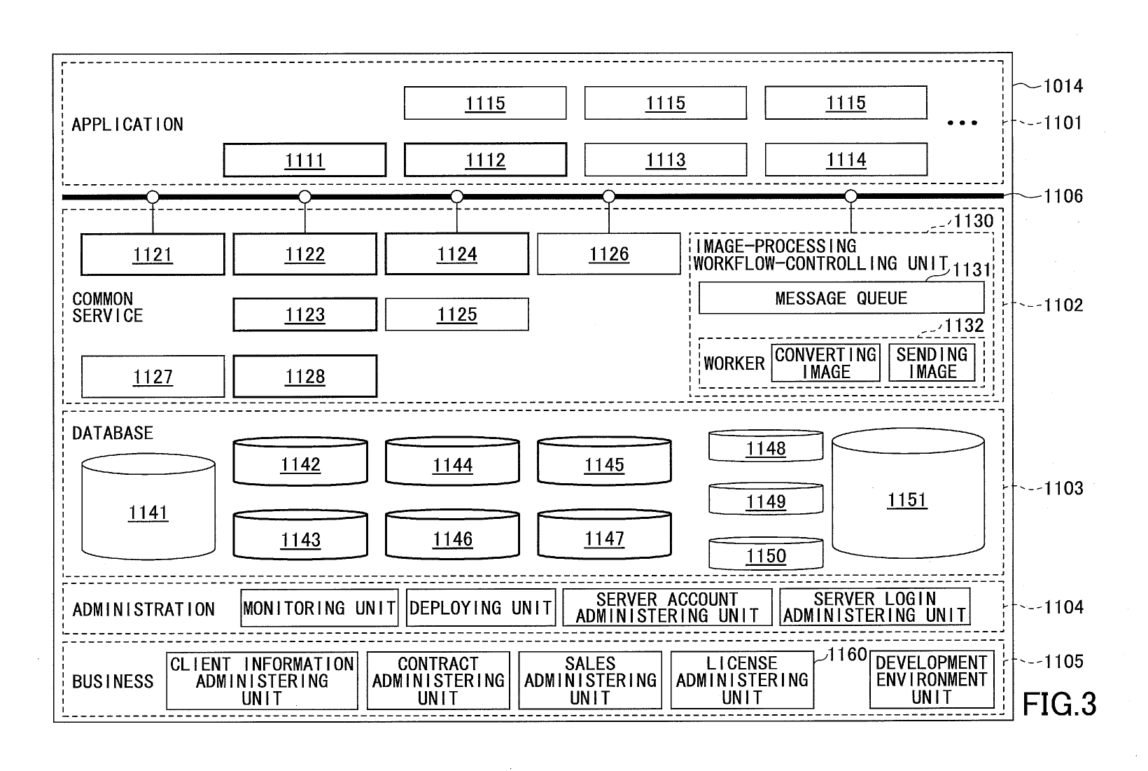

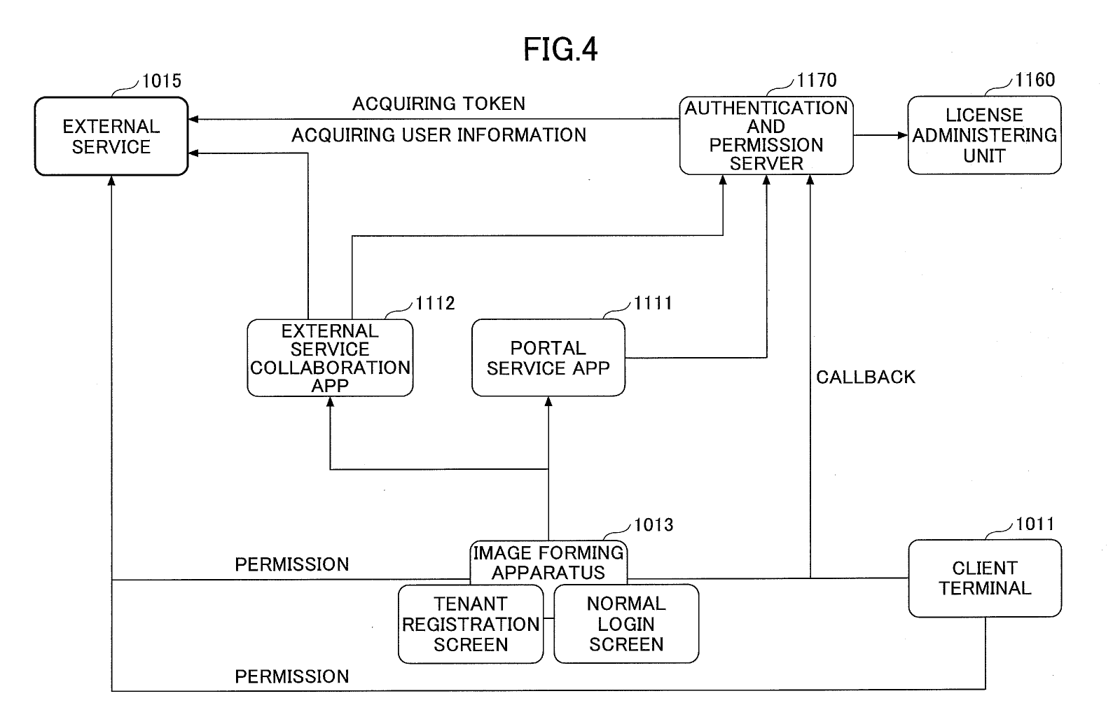

The information processing system 1000 of automatically generating information for using the service providing system 1014 automatically generates the information for using the service providing system 1014 while collaborating as illustrated in, for example, FIG. 4.

FIG. 4 is an explanatory diagram of a summary of a process of automatically generating information for using the service providing system. FIG. 4 illustrates a structure for explaining the information processing system 1000. An authentication and permission server 1170 corresponds to the authentication and permission unit 1121, the tenant administering unit 1122, the user administering unit 1123, the license administering unit 1124, and the external service administering unit 1128. Further, the user who wishes to use the service providing system 1014 through the image forming apparatus 1013 has the account of the external service 1015.

The user attempts to log in the external service collaboration app 1112 from the image forming apparatus 1013, in which the service providing system 1014 is wished to be used. Because there is no authentication ticket, the image forming apparatus 1013 is redirected to a permission screen of the external service 1015. The user performs a login operation to log in the external service 1015 using the permission screen. After the user performs the login operation to log in the external service 1015, the image forming apparatus 1013 acquires the authentication ticket and a permission code, which are of the external service 1015, and calls back to the authentication and permission server 1170.

The authentication and permission server 1170 acquires an access token, an identification (ID) token, and a refresh token from the external service 1015 using the permission code. Further, the authentication and permission server 1170 acquires the user information and domain information, which are stored in the external service 1015, from the external service 1015 using the access token.

The authentication and permission server 1170 causes the license administering unit 1160 to issue the tenant license and the service license, and generates and registers tenant information, user information, external collaboration information, external service tenant information, and external service tenant information, which are described later.

The authentication and permission server 1170 issues the authentication ticket of the service providing system 1014 to the image forming apparatus 1013. Because there is the authentication ticket, the image forming apparatus 1013 is redirected to the external service collaboration app 112. Because there is the authentication ticket, the image forming apparatus 1013 can start use the external service collaboration app 1112 of the service providing system 1014.

As illustrated in FIG. 4, the service providing system 1014 uses the account of the external service 1015 and registers the license information, the tenant information, and the user information, which are information for using the service providing system 1014, through the image forming apparatus 1013. The user is enabled to register the information for using the service providing system 1014 into the service providing system 1014 by the operation from the image forming apparatus 1013. Therefore, the service providing system 1014 is in a usable state.

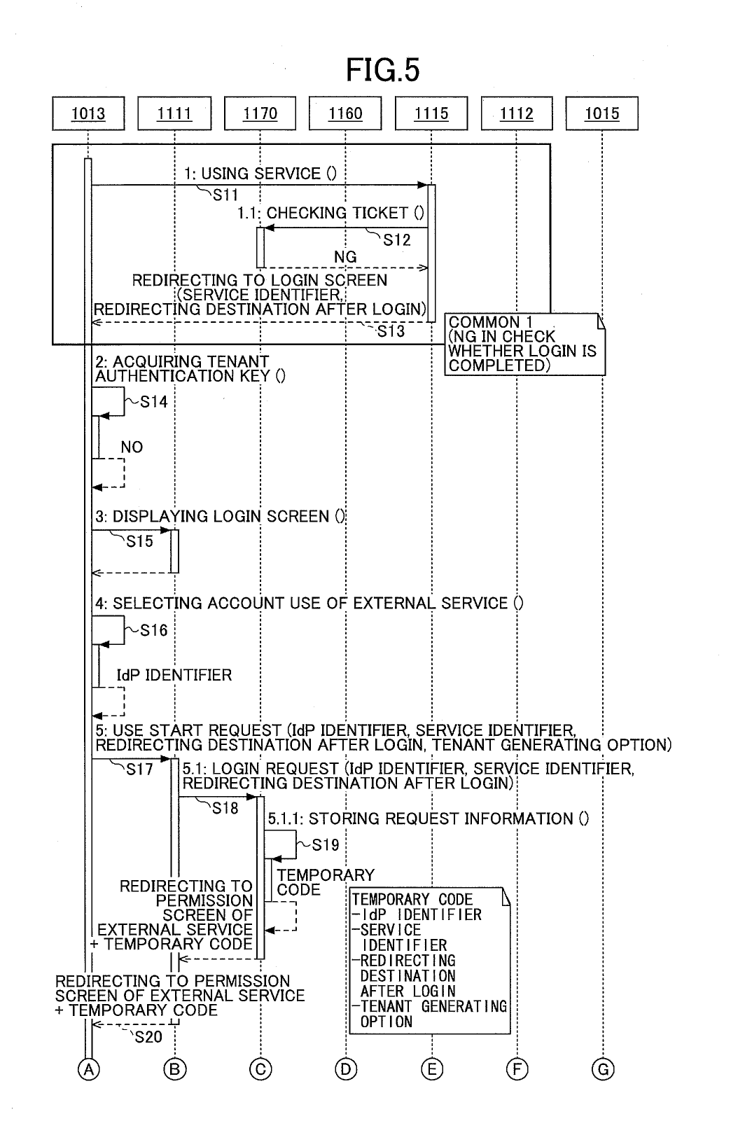

FIGS. 5 to 7 are a sequence diagram of an exemplary process of automatically generating information for using the service providing system. Described next is a procedure that the user having the account of the external service 1015 operates the image forming apparatus 1013 and the information for using the service providing system 1014 is automatically generated. The user requests to log in the external service collaboration app 1112 protected by the authentication ticket from the image forming apparatus 1013, in which the service providing system 1014 is wished by the user to be used.

In step S11, the image forming apparatus 1013 requests the service providing system 1014 for a use of the external service collaboration app 1112 in a state where the authentication ticket of the service providing system 1014 is held. In step S12, the agent 1115 requests the authentication and permission server 1170 for an authenticity check of the request from the image forming apparatus 1013 to the external service collaboration app 1112.

The authentication and permission server 1170 performs the authenticity check of the authentication ticket. Because the request is in the state where the authentication ticket is held, the authentication and permission server 1170 determines that the request is without holding an authenticated authentication ticket.

In step S13, the image forming apparatus 1013 is requested to redirect to a login screen of the service providing system 1014 by the agent 1115. In step S13, a service identifier of the external service collaboration app 1112 and a redirecting destination after the login are reported. Processes of steps S11 to S13 are provided to check whether the login is completed.

In step S14, if a tenant authentication key is stored, the image forming apparatus 1013 acquires the tenant authentication key. Here, the explanation is continued on the premise that the tenant authentication key is not stored. If the tenant authentication key is not stored, the image forming apparatus 1013 sends a request added with a tenant generating option in the following step S17.

In step S15, the image forming apparatus 1013 displays a login screen of the portal service app 1111 of the service providing system 1014. Here, the user selects a use start of the service providing system 1014 using the account of the external service 1015.

In step S17, the image forming apparatus 1013 sends a use start request designating an IdP identifier, a service identifier, a redirecting destination after the login, and a tenant generating option to the portal service app 1111. Here, the IdP identifier is identification information of the external service 1015 selected by the user in step S16.

An apparatus authentication check may be performed in a case where the tenant generating option exists to limit the image forming apparatus 1013 which can send the use start request in step S17.

In step S18, the portal service app 1111 sends a login request designating the IdP identifier, the service identifier, the redirecting destination after the login request, and the tenant generating option to the authentication and permission server 1170. In step S19, the authentication and permission server 1170 stores the IdP identifier, the service identifier, the redirecting destination after the login request, and the tenant generating option, which are designated in the login request, as request information.

The authentication and permission server 1170 reports a temporary code associated with the stored request information to the portal service app 1111, and simultaneously requests the portal service app 1111 to redirect to a permission screen of the external service 1015. In step S20, the image forming apparatus 1013 is requested by the portal service app 1111 to redirect to the permission screen of the external service 1015. The image forming apparatus 1013 displays a login screen for the external service 1015.

The user inputs the authentication information such as the user ID and the password for the external service 1015 into the login screen of the external service 1015 to request the login. In step S21, the image forming apparatus 1013 uses the authentication information such as the user ID and the password, which are for the external service 1015 and are input into the login screen of the external service, to log in and acquire the authentication ticket for the external service 1015.

The process of step S21 is omitted in a case where the login to the external service 1015 is completed. After logging in the external service 1015, the image forming apparatus 1013 adds the authentication ticket for the external service 1015 to access the external service 1015.

In step S22, the image forming apparatus 1013 designates the temporary code and acquires the permission screen from the external service 1015 to display the permission screen. The user performs an operation of the permission on the permission screen displayed in the image forming apparatus 1013,

In step S23, the image forming apparatus 1013 designates the temporary code and requests the external service 1015 of the permission. In step S24, the external service 1015 generates the permission code used to acquire the token. In step S25, the external service 1015 designates the temporary code and the permission code and requests the image forming apparatus 1013 to call back the authentication and permission server 1170. In step S26, the image forming apparatus 1013 designates the temporary code and the permission code and calls back the authentication and permission server 1170. Processes of steps S21 to S26 are to call back.

In step S27, the authentication and permission server 1170 acquires request information of the temporary code designated in the callback in step S26. The acquired request information is the IdP identifier, the service identifier, the redirecting destination after the login request, and the tenant generating option, which are stored in step S19.

In step S28, the authentication and permission server 1170 requests the external service 1015 identified by the IdP identifier to send (acquire) the token using the permission code designated by the callback in step 26. The external service 1015 returns the access token, the ID token, and the refresh token as a response to the request for the token acquisition to the authentication and permission server 1170. In step S29, the authentication and permission server 1170 verifies the ID token and acquires the user identifier of the external service 1015.

In step S30, the authentication and permission server 1170 designates the access token and acquires user information of the external service 1015 from the external service 1015. The user information of the external service 1015 includes, for example, a family name and a mail address. Because the ID token is verified in step S29, the existence of the user of the user information acquired from the external service 1015 is assured in step S30.

In step S31, the authentication and permission server 1170 designates the access token and acquires the domain information of the external service 1015 from the external service 1015. The domain information of the external service 1015 includes, for example, a domain name, a locale, and a country. Here, the association between the domain information of the external service 1015 and the tenant information may be selected. The processes of steps S27 to S31 are to acquire the information from the external service 1015.

In step S32, the authentication and permission server 1170 determines whether there is the already registered user matching the user information of the external service 1015 acquired in step S30. Here, the explanation is given on the premise that there is not the already registered user matching the user information of the external service 1015.

In step S33, the authentication and permission server 1170 determines whether the tenant generating option is included in the request information acquired in step S27. The explanation is given on the premise that the tenant generating option is included in the request information.

In step S34, the authentication and permission server 1170 requests the license administering unit 1160 to issue the tenant license and acquires the tenant license. Further, in step S35, the authentication and permission server 1170 designates the service identifier included in the request information acquired in step S27 and the tenant ID of the tenant license acquired in step S34 and requests the license administering unit 1160 to issue the service license. The authentication and permission server 1170 acquires the service license from the license administering unit 1160.

In step S36, the authentication and permission server 1170 registers the tenant information in the tenant information memory unit 1142 to generate the tenant. The authentication and permission server 1170 sets an initial value of the tenant information using the domain information of the external service 1015 acquired in step S31. Information such as the tenant name which is not included in the domain information of the external service 1015 acquired in step S31 may be set later.

In step S37, the authentication and permission server 1170 generates external service tenant information (described below) associating the tenant ID with the domain information of the external service 1015. The external service tenant information is set in a case where the external service tenant information collaborates with the domain information. For example, the association between the tenant in the service providing system 1014 and the domain of the external service 1015 may be selected by the user as the tenant generating option.

An effect of associating the tenant in the service providing system 1014 with the domain of the external service 1015, the user of the external service 1015 who can use the service providing system 1014 can be limited to a specific domain. Further, the effect of associating the tenant in the service providing system 1014 with the domain of the external service 1015 is that when a user in the same domain firstly uses the service providing system 1014 the tenant adding the user can be automatically determined.

Meanwhile, an effect of not associating the tenant in the service providing system 1014 with the domain of the external service 1015 is that a mail address for a consumer can be used.

In step S38, the authentication and permission server 1170 registers the user information in the user information memory unit 1143 to generate the user. The authentication and permission server 1170 sets an initial value of the user information using the user information of the external service 1015 acquired in step S30. The user ID may be automatically generated from, for example, the mail address.

In step S39, the authentication and permission server 1170 generates external service user information in the external-service user-information memory unit 1147. The external service user information includes the user identifier of the external service 1015, the tenant ID, and the user ID. The external service user information associates the user information of the service providing system 1014 with the user information of the external service 1015.

In step S40, the authentication and permission server 1170 generates external collaboration information associating the access token and the refresh token with the user. The service providing system 1014 uses the access token to use the API of the external service 1015, for example. Processes of steps S38 to S40 are to generate the user.

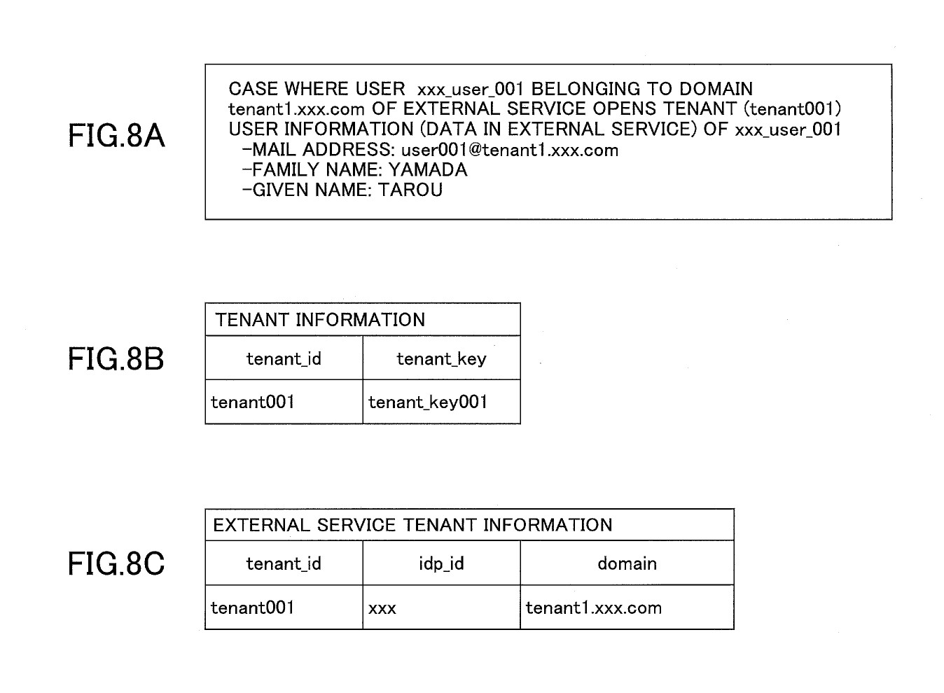

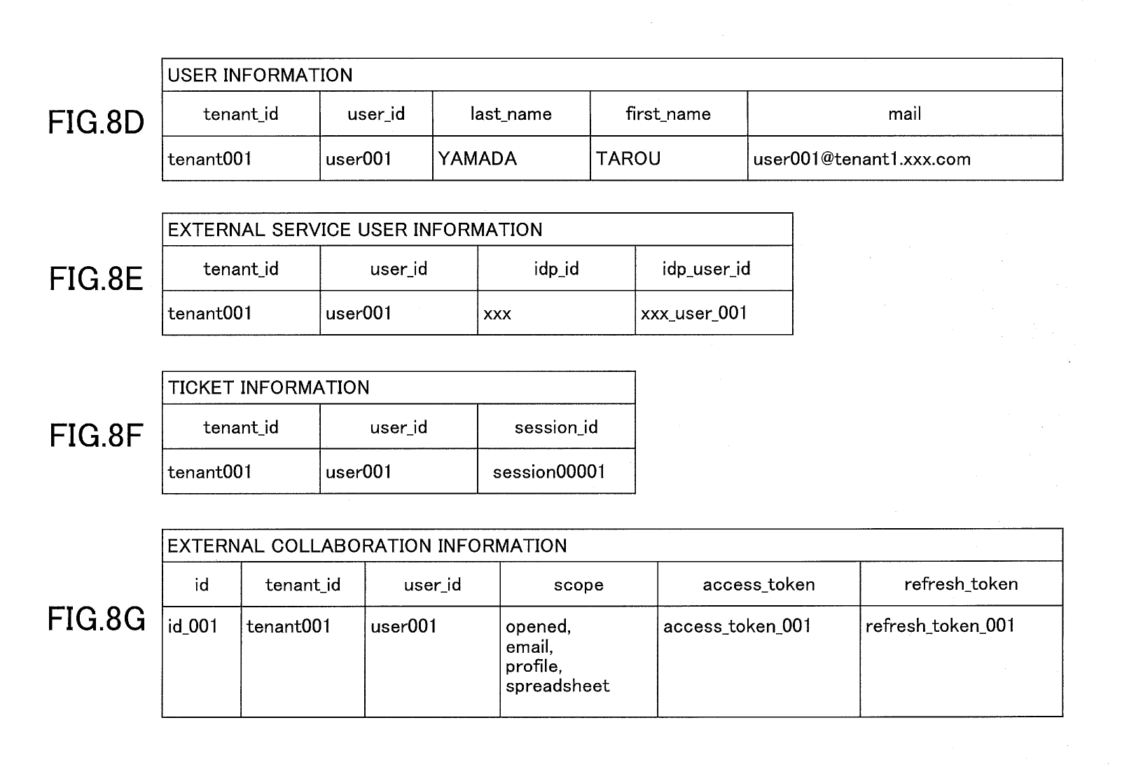

In the processes up to step S40, the tenant information, the external service tenant information, the user information, the external service user information, the ticket information, and the external collaboration information, which are illustrated in FIGS. 8A to 8G.

The tenant information, the external service tenant information, the user information, the external service user information, the ticket information, and the external collaboration information are examples of information for using the service providing system 1014.

FIGS. 8A to 8G are views for explaining exemplary information made by the service providing system by the process up to step S40 illustrated n FIGS. 5 to 7. FIGS. 8A to 8G illustrate an example of opening a tenant “tenant001” by a user “xxx_user_001” belonging to a domain “tenant1.xxx.com” of the external service 1015.

The user information (the user information registered in the external service 1015) of the user “xxx_user_001” is as follows:

Mail address “user001@tenant1.xxx.com”;

Family name “Yamada”; and

Given name “Tarou”.

In the tenant information illustrated in FIG. 8B, the tenant ID “tenant_id” is associated with the tenant authentication key “tenant_key001”. The tenant ID and the tenant authentication key are stored in the image forming apparatus 1013. In the external service tenant information, the tenant ID, the IdP identifier “idp_id”, and the domain “tenant1.xxx.com” are associated.

In the user information, the tenant ID, the user ID “user_id”, the family name “last_name”, the given name “first_name”, and the mail address “mail” are associated.

In the external service user information, the tenant ID, the user ID, the IdP identifier, and the user identifier “idp_user_id” of the external service 1015 are associated. In the external collaboration information, the ID “id”, the tenant ID, the user ID, the scope “scope”, the access token “access_token”, and the refresh token “refresh_token” are associated.

In the ticket information, the tenant ID, the user ID, and the session ID “session00001” are associated. The ticket information illustrated in FIGS. 8A to 8G is used to administer the authentication ticket of the service providing system 1014 and maintain a login state using the session ID. The tenant information and the user information, which are made by the service providing system 1014, can be revised using the portal service app 1111.

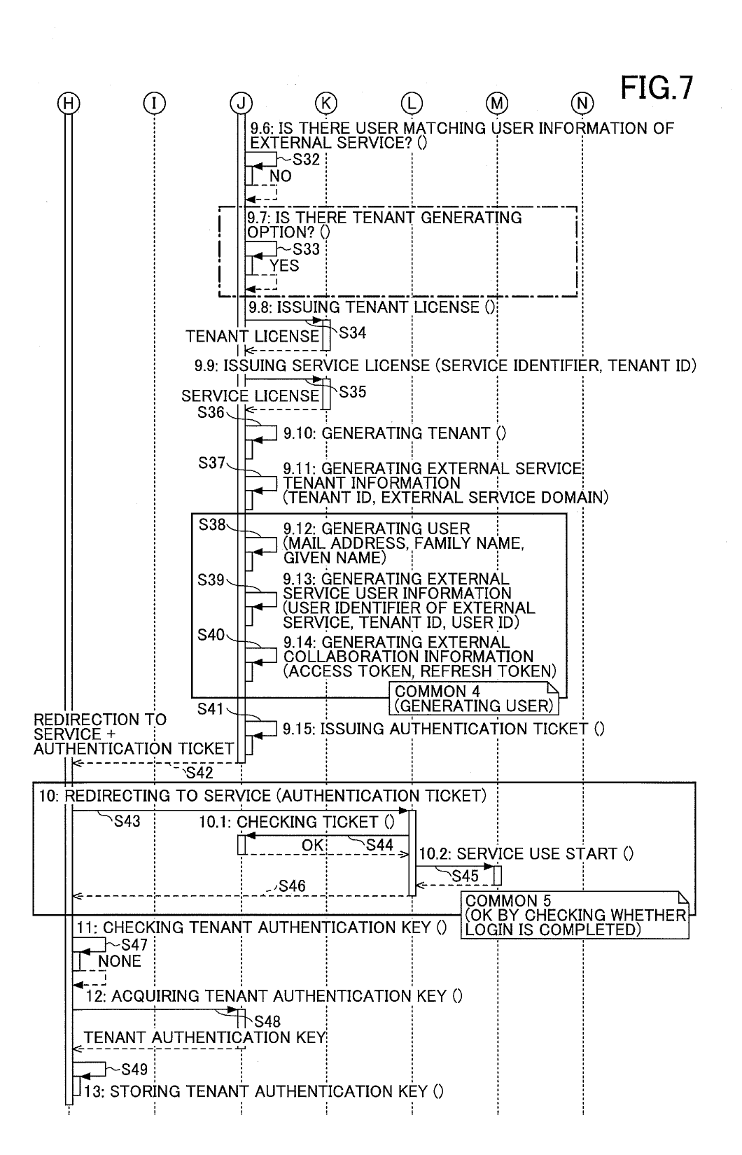

Referring back to step S41 of FIG. 7, the authentication and permission server 1170 issues the authentication ticket based on the ticket information illustrated in FIG. 8. In step S42, the authentication and permission server 1170 reports the authentication ticket of the service providing system 1014 issued in step S41 to the image forming apparatus 1013, and simultaneously requests the image forming apparatus 1013 to redirect to the external service collaboration app 1112. As described, the service providing system 1014 issues the authentication ticket of the service providing system 1014 to the made user and receives a login process from the image forming apparatus 1013.

In step S43, the image forming apparatus 1013 requests the service providing system 1014 for a use of the external service collaboration app 1112 in a state where the authentication ticket of the service providing system 1014 is held. In step S44, the agent 1115 requests the authentication and permission server 1170 for an authenticity check of the request from the image forming apparatus 1013 to the external service collaboration app 1112.

The authentication and permission server 1170 performs the authenticity check of the authentication ticket. Here, the request is determined to have the authenticated authentication ticket by the authentication and permission server 1170. In step S45, the agent 1115 sends the request from the image forming apparatus 1013 to the external service collaboration app 1112 to cause the image forming apparatus 1013 to use the external service collaboration app 1112. Further, the agent 1115 returns a response to the request in step S43 to the image forming apparatus 1013 in step S46. Processes of steps S43 to S46 are provided to check whether the login is completed.

In step S47, the image forming apparatus 1013 checks whether the tenant authentication key is stored. Here, the explanation is continued on the premise that the tenant authentication key is not stored. In step S48, the image forming apparatus 1013 acquires the tenant authentication key from the authentication and permission server 1170. In step S49, the image forming apparatus 1013 stores the tenant authentication key. The image forming apparatus 1013 stores the tenant ID and the tenant authentication key after logging in the service providing system 1014.

According to the information processing system 1000 of the first embodiment, the use start of the service providing system 1014 can be done from the image forming apparatus 1013. Because the use start of the service providing system 1014 is done from the image forming apparatus 1013 using the service providing system 1014, the user can easily understand.

In a case where the tenant authentication key is not stored, the image forming apparatus 1013 adds the tenant generating option to the use start request for the service providing system 1014. In a case where the tenant generating option is added, an apparatus authentication check is performed to enable the information processing system 1000 to limit the image forming apparatus 1013 which can perform the use start request to the service providing system 1014. By limiting the image forming apparatus 1013 which can open the tenant, the information processing system 1000 of the first embodiment can prevent a PC, a server, or the like from attacking.

Further, the information processing system 1000 of the first embodiment can use an effective mail address registered in the external service 1015 to prevent the mail address of the user from being verified.

As such, since the information processing system 1000 of the first embodiment can do the use start of the service providing system 1014 from the image forming apparatus 1013 without using the terminal apparatus, a time and effort of the user can be reduced.

### <<Login Using Account of External Service>>

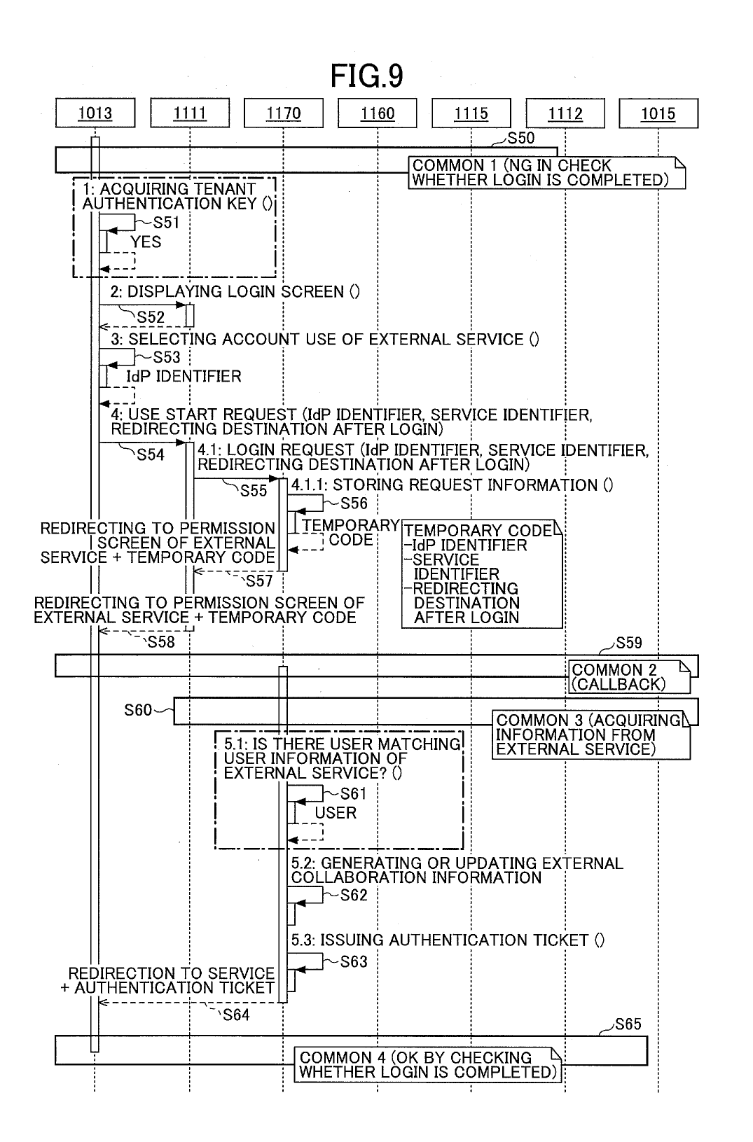

After the processes illustrated in the sequence diagram illustrated in FIGS. 5 to 7, the service providing system 1014 can be logged in using the account of the external service 1015 so as to be used. FIG. 9 is a sequence diagram of an exemplary login process using the account of the external service. Because the sequence diagram of FIG. 9 is similar to the sequence diagram of FIGS. 5 to 7, the explanation is appropriately omitted.

The process of step S50 is similar to the process of steps S11 to S13 of FIG. 5. In step S51, if the tenant authentication key is stored, the image forming apparatus 1013 acquires the tenant authentication key.

Here, the explanation is continued on the premise that the tenant authentication key is stored. If the tenant authentication key is stored, the image forming apparatus 1013 sends a request added with no tenant generating option in the following step S54.

In step S52, the image forming apparatus 1013 displays a login screen of the portal service app 1111 of the service providing system 1014. In step S53, the user selects the use start of the service providing system 1014 using the account of the external service 1015.

In step S54, the image forming apparatus 1013 sends the use start request designating the IdP identifier, the service identifier, and the redirecting destination after the login to the portal service app 1111.

In step S55, the portal service app 1111 sends a login request designating the IdP identifier, the service identifier, and the redirecting destination after the login to the authentication and permission server 1170. In step S56, the authentication and permission server 1170 stores the IdP identifier, the service identifier, and the redirecting destination after the login request, which are designated in the login request, as request information.

The authentication and permission server 1170 reports a temporary code associated with the stored request information to the portal service app 1111, and simultaneously requests the portal service app 1111 to redirect to the permission screen of the external service 1015. In step S58, the image forming apparatus 1013 is requested by the portal service app 1111 to redirect to the permission screen of the external service 1015. The image forming apparatus 1013 displays a login screen for the external service 1015.

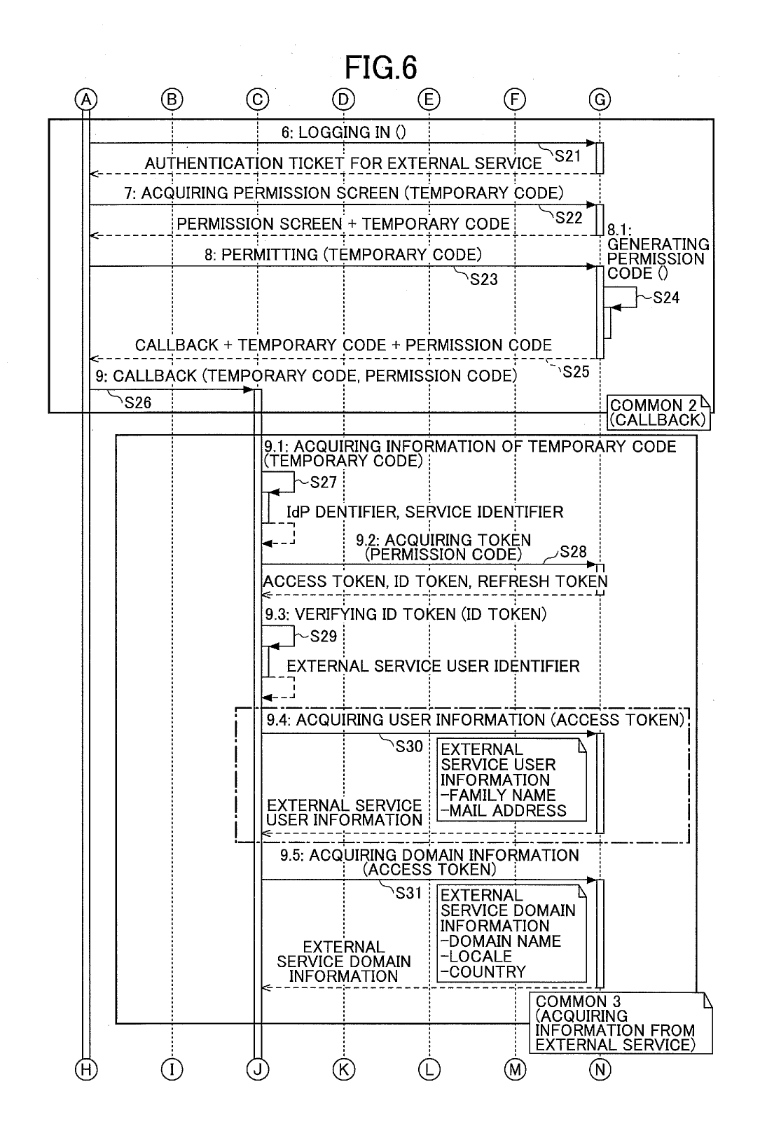

The process of step S59 is similar to the process of steps S21 to S26 of FIG. 6. The process of step S60 is similar to the process of steps S27 to S31 of FIG. 6.

In step S61, the authentication and permission server 1170 determines whether there is a user matching the user information of the external service 1015 acquired from the external service 1015. Here, the explanation is given on the premise that there is the already registered user matching the user information of the external service 1015.

In step S62, the authentication and permission server 1170 generates or updates external collaboration information associating the access token and the refresh token with the user. In step S63, the authentication and permission server 1170 issues the authentication ticket.

In step S64, the authentication and permission server 1170 reports the authentication ticket of the service providing system 1014 issued in step S63 to the image forming apparatus 1013, and simultaneously requests the image forming apparatus 1013 to redirect to the external service collaboration app 1112. The process of step S65 is similar to the process of steps S43 to S46 of FIG. 7.

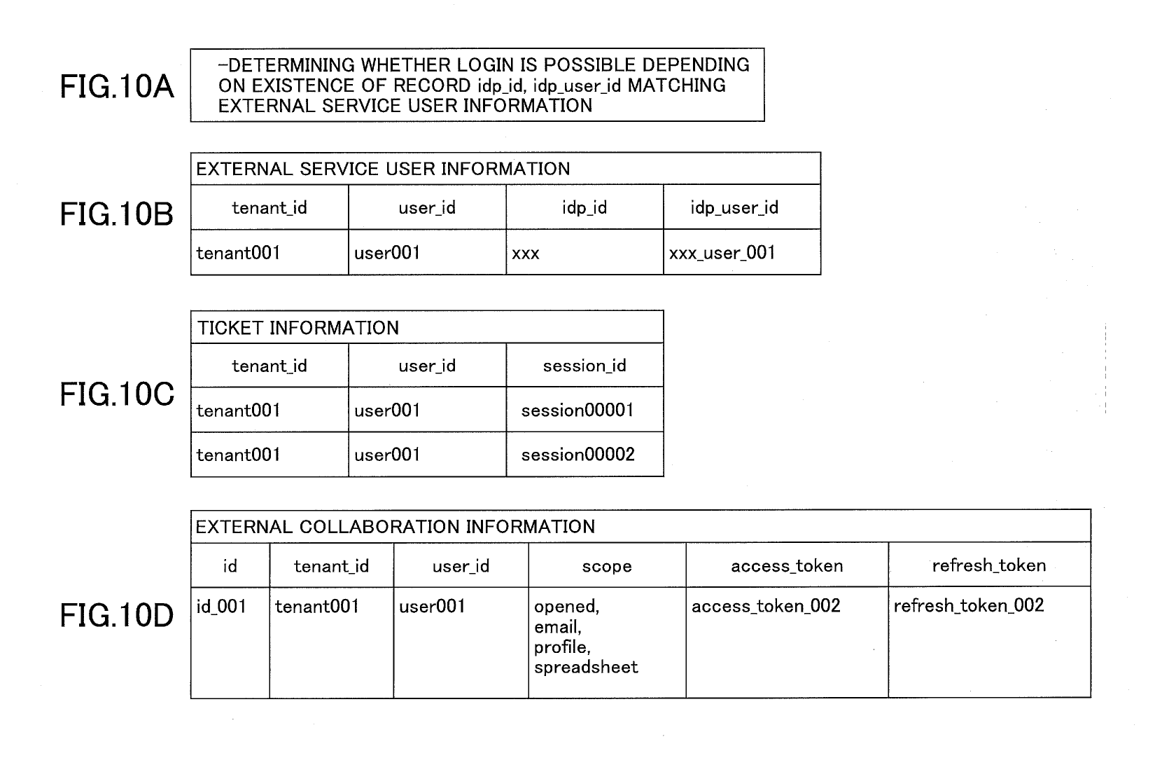

FIGS. 10A to 10D are views for explaining exemplary processes of steps S61 to S63 illustrated in FIG. 9. In step S61, the authentication and permission server 1170 determines whether there is a record matching the Idp identifier and the user identifier, which are of the external service 1015 and are acquired from the external service 1015.

If there is the record matching the Idp identifier and the user identifier, which are of the external service 1015 and are acquired from the external service 1015, the authentication and permission server 1170 determines that there is the user matching the user information matching the user information, which is of the external service 1015 and is acquired from the external service 1015. If there is not the record matching the Idp identifier and the user identifier, which are of the external service 1015 and are acquired from the external service 1015, the authentication and permission server 1170 determines that there is not the user matching the user information, which is of the external service 1015 and is acquired from the external service 1015.

Further, in step S62, the authentication and permission server 1170 updates an access token and a refresh token, which are of a record whose user ID and scope of the external collaboration information match, with newly acquired access token and refresh token.

If there is not the record whose user ID and scope of the external collaboration information match in the external collaboration information, the authentication and permission server 1170 generates a new record, in which the newly acquired access token and refresh token are registered.

The login process using the account of the external service is combined with the tenant authentication key to refuse the login by the user of the external service 1015 associated with the tenant which does not correspond. In this case, after the process of step S61 illustrated in, for example, FIG. 9, the tenant information is acquired using the tenant authentication key. The authentication and permission server 1170 determines whether the login is by the user of the external service 1015, which does not correspond, depending on whether the tenant including the user acquired in step S61 matches the tenant acquired using the tenant authentication key.

<<Association with Tenant at Time of Adding New User>>

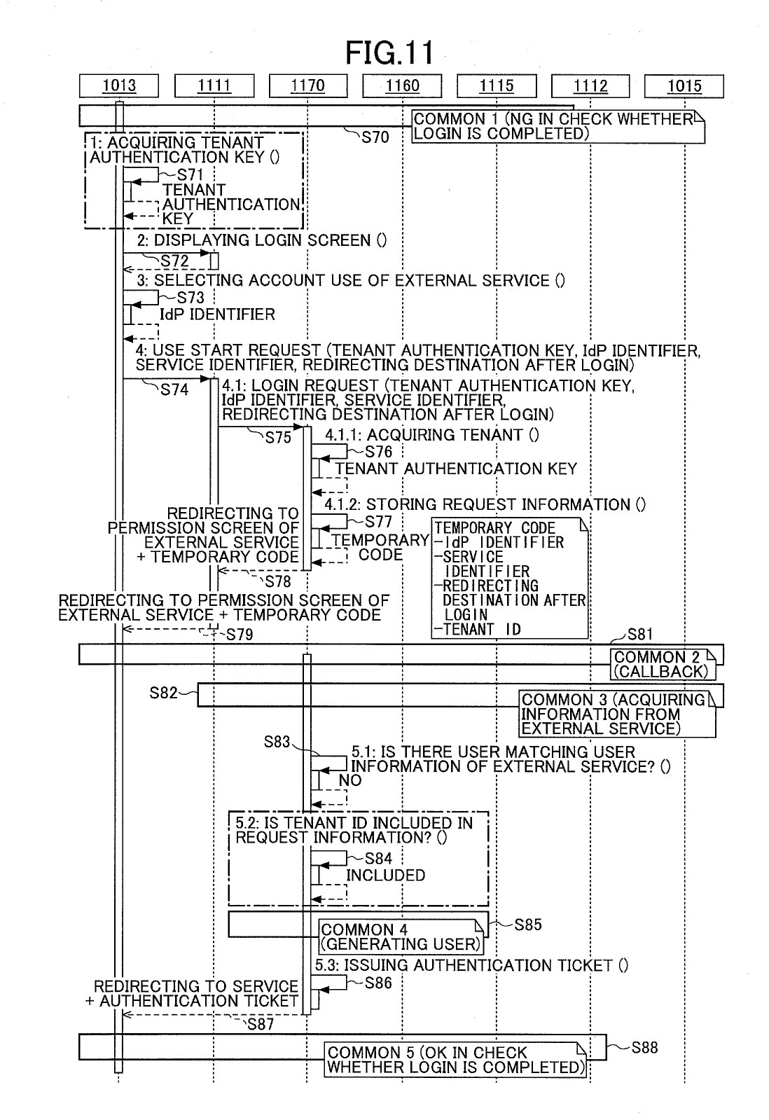

For example, the service providing system 1014 can add the account of the new user at a timing when the new user first logs in as illustrated in FIG. 11. Here, the addition of the account of the new user is, for example, an addition of the account from the image forming apparatus 1013.

FIG. 11 is a sequence diagram of an exemplary process of associating with the tenant at a time of adding the new user. Because the sequence diagram of FIG. 11 is similar to the sequence diagram of FIGS. 5 to 7, the explanation is appropriately omitted.

The process of step S70 is similar to the process of steps S11 to S13 of FIG. 5. In step S71, if the tenant authentication key is stored, the image forming apparatus 1013 acquires the tenant authentication key.

Here, the explanation is continued on the premise that the tenant authentication key is stored. If the tenant authentication key is stored, the image forming apparatus 1013 sends a request added with the tenant authentication key in the following step S74.

In step S72, the image forming apparatus 1013 displays a login screen of the portal service app 1111 of the service providing system 1014. In step S73, the user selects the use start of the service providing system 1014 using the account of the external service 1015.

In step S74, the image forming apparatus 1013 sends the use start request designating the tenant authentication key, the IdP identifier, the service identifier, and the redirecting destination after the login to the portal service app 1111.

In step S75, the portal service app 1111 sends a login request designating the tenant authentication key, the IdP identifier, the service identifier, and the redirecting destination after the login to the authentication and permission server 1170. In step S76, the authentication and permission server 1170 acquires the tenant ID corresponding to the tenant authentication key from the tenant information.

In step S77, the authentication and permission server 1170 stores the IdP identifier, the service identifier, the redirecting destination after the login request, and the tenant ID acquired in step S76, as request information.

The authentication and permission server 1170 reports a temporary code associated with the stored request information to the portal service app 1111, and simultaneously requests the portal service app 1111 to redirect to the permission screen of the external service 1015. In step S79, the image forming apparatus 1013 is requested by the portal service app 1111 to redirect to the permission screen of the external service 1015. The image forming apparatus 1013 displays a login screen for the external service 1015.

The process of step S81 is similar to the process of steps S21 to S26 of FIG. 6. The process of step S82 is similar to the process of steps S27 to S31 of FIG. 6.

In step S83, the authentication and permission server 1170 determines whether there is a user matching the user information of the external service 1015 acquired from the external service 1015. Here, the explanation is given on the premise that there is not the user matching the user information of the external service 1015.

In step S84, the authentication and permission server 1170 determines whether the tenant ID is included in the request information acquired in step S77. Here, the explanation is continued on the premise that the tenant ID is included in the request information stored in step S77.

In step S85, by processes similar to steps S38 to S40 illustrated in FIG. 7, the new user is added to the tenant of the tenant ID included in the request information. In step S86, the authentication and permission server 1170 issues the authentication ticket.

In step S87, the authentication and permission server 1170 reports the authentication ticket of the service providing system 1014 issued in step S86 to the image forming apparatus 1013, and simultaneously requests the image forming apparatus 1013 to redirect to the external service collaboration app 1112. The process of step S88 is similar to the process of steps S43 to S46 of FIG. 7.

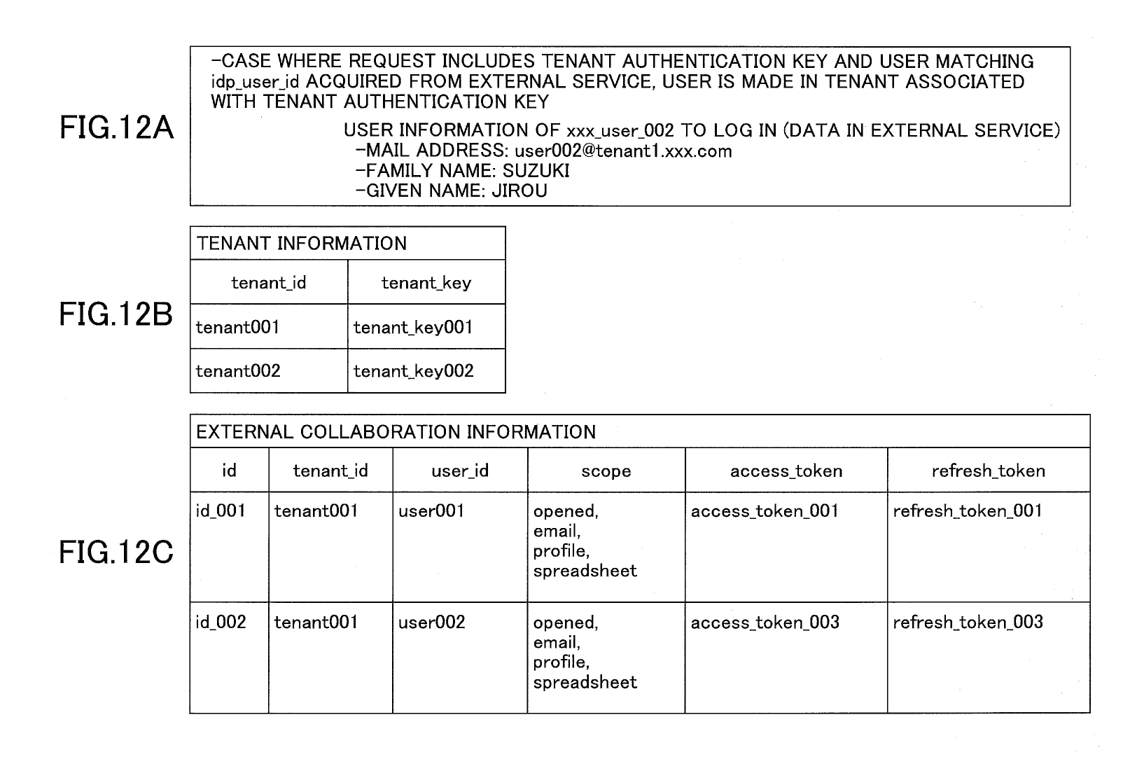

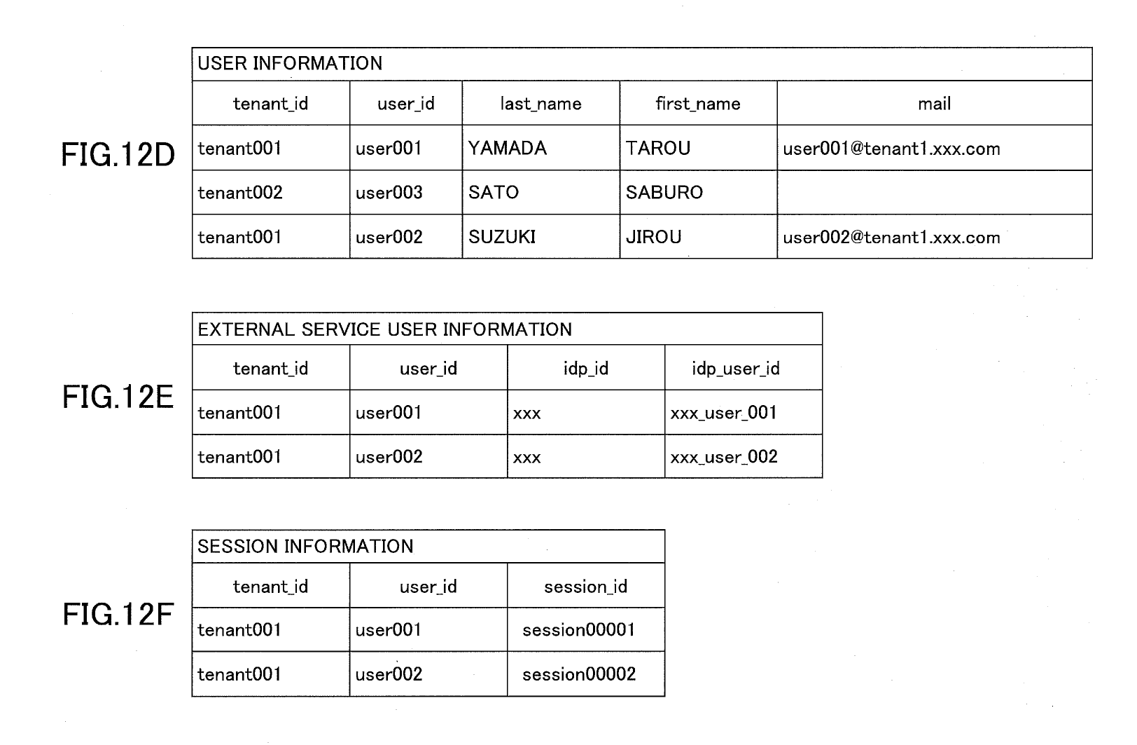

FIGS. 12A to 12F are views for explaining exemplary processes of steps S84 to S86 illustrated in FIG. 11. For example, in step S84, the authentication and permission server 1170 determines that the tenant ID “tenant001” is included in the request information stored in step S77.

In step S85, the authentication and permission server 1170 generates the external collaboration information, the user information, the external service user information, and the session information to add the new user having the user ID “user002” to the tenant having the tenant ID “tenant001”.

According to the sequence diagram illustrated in FIG. 11, the new user can be added to the tenant corresponding to the tenant authentication key which is held by the image forming apparatus 1013.

### [General Overview]

Therefore, the information processing system 1000 of the first embodiment uses the account of the external service 1015 by the operation from the image forming apparatus 1013 to enable to use the service providing system 1014.

Further, according to the information processing system 1000 of the first embodiment, the login to the service providing system 1014, which collaborates with the external service 1015, can be performed using the account of the external service 1015.

Further, according to the information processing system 1000 of the first embodiment, the account of the service providing system 1014 can be automatically added at a timing when the new user having the account of the external service 1015 initially logs in the service providing system 1014. Therefore, according to the information processing system 1000 of the first embodiment, it is possible to reduce an account administration cost for the service providing system 1014 by an administrator.

### Second Embodiment

Within the first embodiment, the new user is added to the tenant corresponding to the tenant authentication key which is held by the image forming apparatus 1013. Within the second embodiment, the new user is added to the tenant corresponding to the domain in the external service tenant information. Here, the account of the new user is added from, for example, a terminal apparatus such as the client terminal 1011.

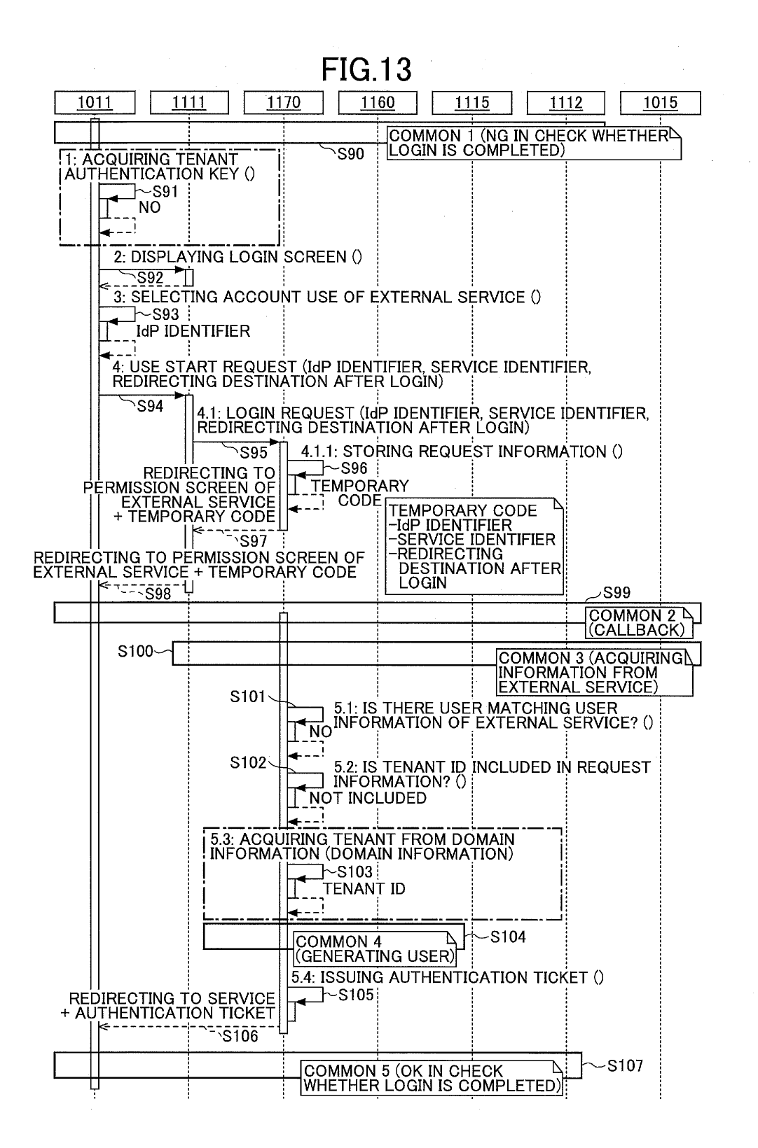

For example, the service providing system 1014 can add the account of the new user at a timing when the new user first logs in as illustrated in FIG. 13. FIG. 13 is a sequence diagram of another exemplary process of associating with the tenant at the time of adding the new user.

Because the sequence diagram of FIG. 13 is similar to the sequence diagram of FIGS. 5 to 7, the explanation is appropriately omitted. For example, in the sequence diagram illustrated of FIG. 13, the image forming apparatus in FIGS. 5 to 7 are replaced by the client terminal 1011.

The process of step S90 is similar to the process of steps S11 to S13 of FIG. 5. In step S91, if the tenant authentication key is stored, the client terminal 11 acquires the tenant authentication key.

Here, the explanation is continued on the premise that the tenant authentication key is not stored. If the tenant authentication key is not stored, the client terminal 1011 sends a request added without adding the tenant authentication key in the following step S94.

In step S92, the client terminal 1011 displays the login screen of the portal service app 1111 of the service providing system 1014. In step S93, the user selects the use start of the service providing system 1014 using the account of the external service 1015.

In step S94, the client terminal 1011 sends the use start request designating the IdP identifier, the service identifier, and the redirecting destination after the login to the portal service app 1111.

In step S95, the portal service app 1111 sends a login request designating the IdP identifier, the service identifier, and the redirecting destination after the login to the authentication and permission server 1170.

In step S96, the authentication and permission server 1170 stores the IdP identifier, the service identifier, and the redirecting destination after the login request, which are designated in the login request, as request information.

The authentication and permission server 1170 reports a temporary code associated with the stored request information to the portal service app 1111, and simultaneously requests the portal service app 1111 to redirect to the permission screen of the external service 1015. In step S98, the client terminal 1011 is requested by the portal service app 1111 to redirect to the permission screen of the external service 1015. The client terminal 1011 displays a login screen for the external service 1015.

The process of step S99 is similar to the process of steps S21 to S26 of FIG. 6. The process of step S100 is similar to the process of steps S27 to S31 of FIG. 6.

In step S101, the authentication and permission server 1170 determines whether there is a user matching the user information of the external service 1015 acquired from the external service 1015. Here, the explanation is given on the premise that there is not the user matching the user information of the external service 1015.

In step S102, the authentication and permission server 1170 determines whether the tenant ID is included in the request information acquired in step S96. Here, the explanation is continued on the premise that the tenant ID is included in the request information stored in step S96.

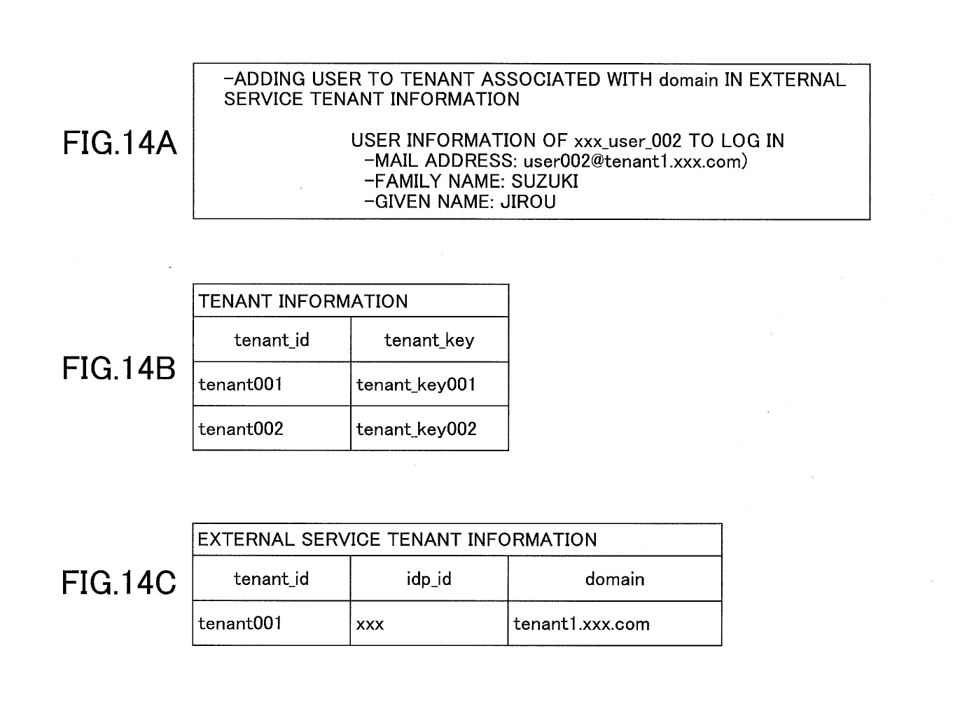

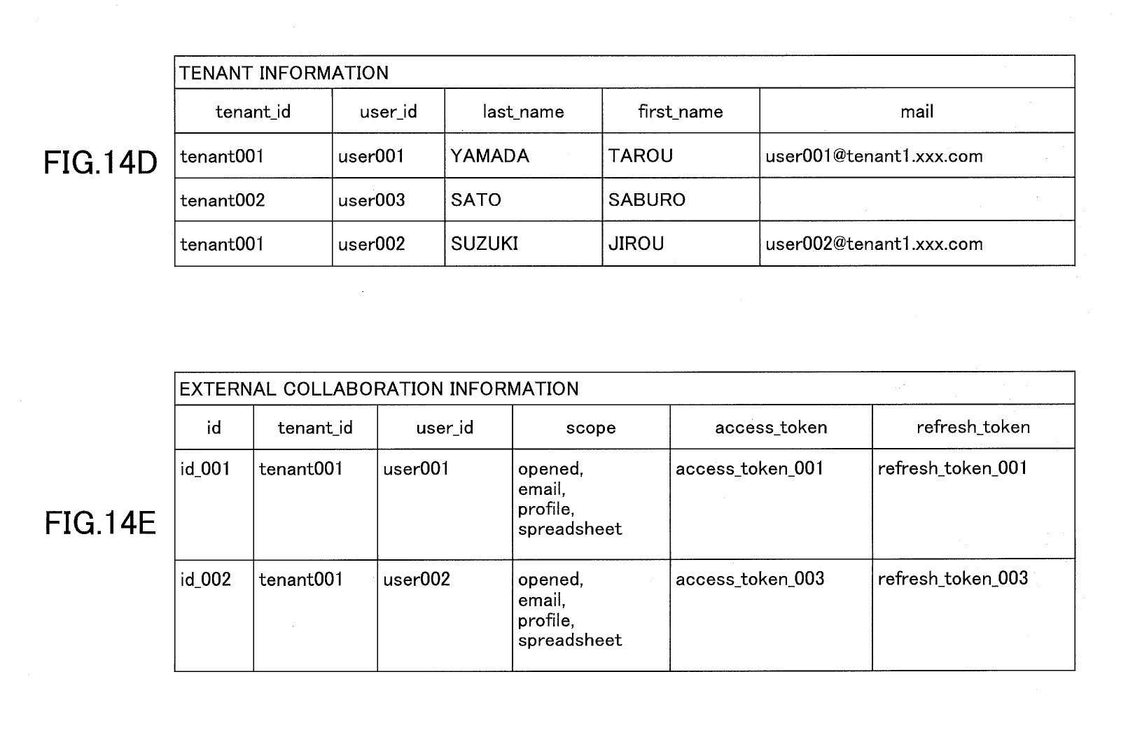

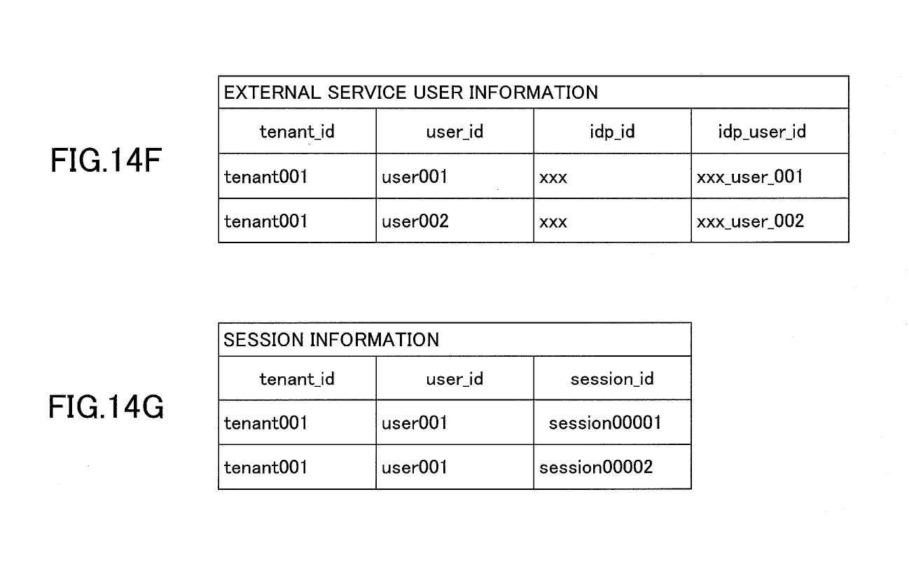

In step S103, the authentication and permission server 1170 acquires the tenant ID corresponding to the domain from the external service tenant information illustrated in FIGS. 14A to 14F. It may be set whether a user in the matching domain can be added to the tenant for each tenant. In a case where the user is not to be automatically added, it is possible to report to the administrator or the like of the tenant by, for example, an email to acquire the permission of the administrator or the like of the tenant.

In step S104, by a process similar to steps S38 to S40 illustrated in FIG. 7, the new user is added to the tenant of the tenant ID corresponding to the domain. In step S105, the authentication and permission server 1170 issues the authentication ticket.

In step S106, the authentication and permission server 1170 reports the authentication ticket of the service providing system 1014 issued in step S105 to the client terminal 1011, and simultaneously requests the client terminal 1011 to redirect to the external service collaboration app 1112. The process of step S107 is similar to the process of steps S43 to S46 of FIG. 7.

FIGS. 14A to 14F are views for explaining exemplary processes of steps S103 to S105 illustrated in FIG. 13. For example, in step S103, the authentication and permission server 1170 acquires the tenant ID “tenant001” corresponding to the domain “tenant1.xxx.com” of the external service 1015 from the external service tenant information.

In step S104, the authentication and permission server 1170 generates the external collaboration information, the user information, the external service user information, and the session information to add the new user having the user ID “user002” to the tenant having the tenant ID “tenant001”.

According to the sequence diagram of FIG. 13, the new user can be added to the tenant corresponding to the domain in the external service tenant information.

### Third Embodiment

The third embodiment is to prevent the new tenant from being made in a case where the tenant authentication key stored in the image forming apparatus 1013 is deleted and another image forming apparatus 1013 is used.

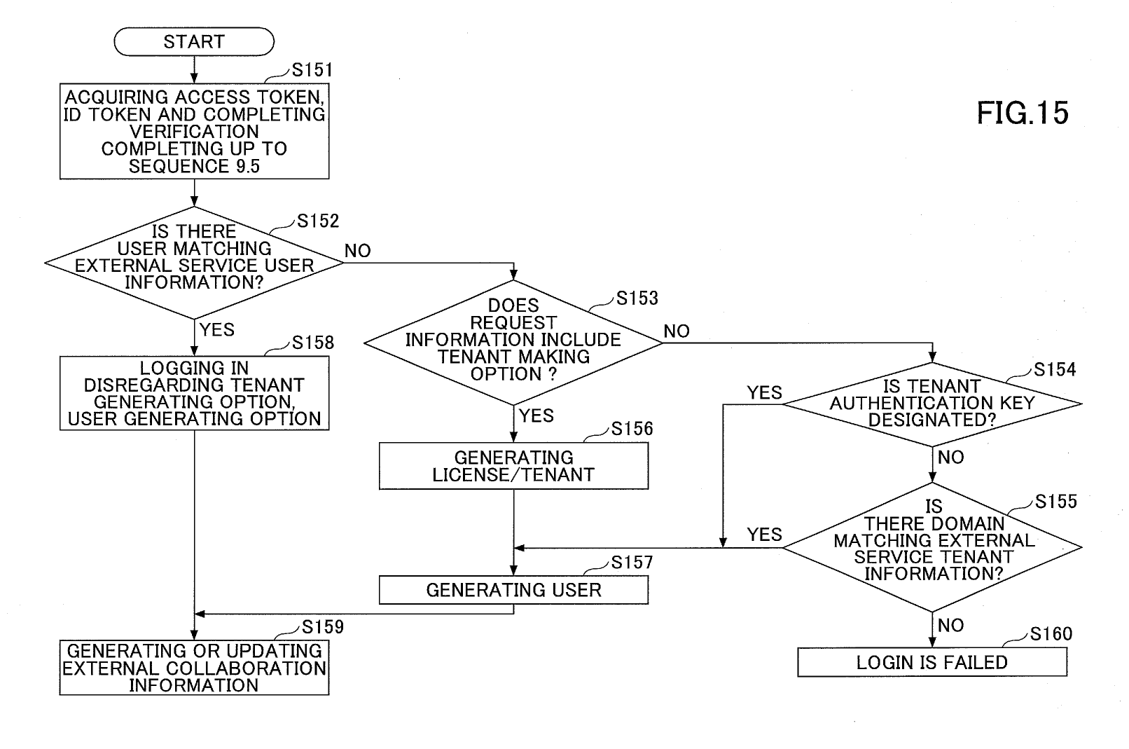

FIG. 15 is a flowchart of an exemplary process of determining whether a new tenant is made. In step S151, the process from step S11 of FIG. 5 to step S31 of FIG. 6 is conducted.

In step S152, the authentication and permission server 1170 determines whether there is a user matching the external service user information. In a case where there is the user matching the external service user information, the authentication and permission server 1170 disregards the tenant generating option and the user generating option and conducts a login process. In step S159, the authentication and permission server 1170 generates and updates the external collaboration information. The tenant authentication key is stored in the image forming apparatus 1013 after the login process.

On the other hand, in a case where there is not the user matching the external service user information in step S152, the authentication and permission server 1170 determines whether the request information includes the tenant generating option. If the request information includes the tenant generating option, the authentication and permission server 1170 proceeds to step S156 to issue the above described tenant license and service license and generate the tenant. After the authentication and permission server 1170 generates the above user in step S157, the authentication and permission server 1170 generates and updates the external collaboration information in step S159.

On the other hand, if the request information does not include the tenant generating option, the authentication and permission server 1170 proceeds to step S154. The authentication and permission server 1170 determines whether the tenant authentication key is designated in the tenant information. If the tenant authentication key is designated in the tenant information, the authentication and permission server 1170 generates the user in step S157 as described above and thereafter generates and updates the external collaboration information in step S159.

On the other hand, if the tenant authentication key is not designated in the tenant information in step S154, the authentication and permission server 1170 proceeds to step S155 to determine whether there is the domain matching the external service tenant information. If there is the domain matching the external service tenant information, after the authentication and permission server 1170 generates the above user in step S157, the authentication and permission server 1170 generates and updates the external collaboration information in step S159. On the other hand, if there is not the domain matching the external service tenant information, the authentication and permission server 1170 determines that the login is failed in step S160.

The flowchart of FIG. 15 is to prevent the new tenant from being made in a case where the tenant authentication key stored in the image forming apparatus 1013 is deleted and the other image forming apparatus 1013 is used.

The tenant information is an example of organization information recited in claims. The authentication function of the service providing system 1014 is an example of a first authentication function. The external service collaboration app 1112 of providing the first service is an example of a service providing system.

The authentication function of the external service 1015 is an example of a second authentication function. The authentication and permission server 1170 is an example of a service-use information generating unit. The external service collaboration app 1112 is an example of a service providing unit. The service use information is an example of tenant information, external tenant information, user information, external service user information, session information, and external collaboration information. The tenant authentication key is an example of organization authentication information.

According to the embodiment, it is possible to easily substantialize a state where a service is used by an operation from the image forming apparatus.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the service providing system has been described in detail, it should be understood that various changes, substitutions, and alterations could be made thereto without departing from the spirit and scope of the invention.

A method carried out based on this disclosure is not limited to the disclosed order of processes of the method.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.”

What is claimed is:

1. A service providing system of providing a first service to an image forming apparatus authenticated by a first authentication function authenticating using registered organization information and registered user information, the service providing system comprising a hardware processor which executes an application program to implement:
a use-request receiving unit configured to receive a use request to use the first service from the image forming apparatus, which is operated by a user;
a service-use information generating unit configured to, in a case where the received use request is from the image forming apparatus, which is operated by the user, who is not authenticated by the first authentication function, acquire information related to the user, who operates the image forming apparatus and is authenticated by a second authentication function from another service providing system providing a second service to the image forming apparatus authenticated by the second authentication function and generate service use information that includes the organization information and the user information and is for using the first service using the information related to the user; and
a service providing unit configured to provide the first service to the image forming apparatus, which is operated by the user authenticated by the second authentication function.

2. The service providing system according to claim 1,
wherein the service providing unit processes in collaboration with the another service providing system providing the second service.

3. The service providing system according to claim 2,
wherein the service-use information generating unit generates the service use information associating the user authenticated by the first authentication function with the user authenticated by the second authentication function, and
wherein the service providing unit determines the authentication done by the first authentication function using a result of the authentication done by the second authentication function.

4. The service providing system according to claim 3,
wherein, in a case where the service-use information generating unit generates the service use information including the organization information for using the first service of a new user and the user information, the service-use information generating unit generates the organization information associated with the organization authentication information and the service use information including the user information of the new user based on the organization authentication information registered in the image forming apparatus.

5. The service providing system according to claim 4,
wherein, in a case where the organization information associated with the organization authentication information does not match the organization information associated with the user authenticated by the second authentication function, the service providing unit limitedly provides the first service to the image forming apparatus.

6. The service providing system according to claim 3,
wherein, in a case where the service-use information generating unit generates the service use information including the organization information for using the first service of a new user and the user information, the service-use information generating unit generates the organization information associated with domain information of the another service providing system and the service use information including the user information of the new user.

7. An information processing apparatus of providing a first service to an image forming apparatus authenticated by a first authentication function authenticating using registered organization information and registered user information, the information processing apparatus comprising a hardware processor which executes an application program to implement:
a use-request receiving unit configured to receive a use request to use the first service from the image forming apparatus, which is operated by a user;
a service-use information generating unit configured to, in a case where the received use request is from the image forming apparatus, which is operated by the user, who is not authenticated by the first authentication function, acquire information related to the user, who operates the image forming apparatus and is authenticated by a second authentication function from another service providing system providing a second service to the image forming apparatus authenticated by the second authentication function and generate service use information that includes the organization information and the user information and is for using the first service using the information related to the user; and
a service providing unit configured to provide the first service to the image forming apparatus, which is operated by the user authenticated by the second authentication function.

8. A method for generating service usage information performed by a service providing system of providing a first service to an image forming apparatus authenticated by a first authentication function authenticating using registered organization information and registered user information, the method comprising:
receiving a use request to use the first service from the image forming apparatus, which is operated by a user;
acquiring, in a case where the received use request is from the image forming apparatus, which is operated by the user, who is not authenticated by the first authentication function, information related to the user, who operates the image forming apparatus and is authenticated by a second authentication function from another service providing system providing a second service to the image forming apparatus authenticated by the second authentication function and generating service use information that includes the organization information and the user information and is for using the first service using the information related to the user; and
providing the first service to the image forming apparatus, which is operated by the user authenticated by the second authentication function.
